(19) United States
(12) Patent Application Publication
(10) Pub. No.: US 2025/0303825 A1
(43) Pub. Date: Oct. 2, 2025

(54) DUAL INVERTER TWO-CYCLE ROOF MOUNTED AIR CONDITIONING SYSTEM FOR A MOTORIZED VEHICLE

(71) Applicants: HYUNDAI MOTOR COMPANY, Seoul (KR); KIA CORPORATION, Seoul (KR)

(72) Inventors: Nam-Seok Yun, Hwaseong-si (KR); Bo-Hyeon Ryu, Hwaseong-si (KR)

(73) Assignees: HYUNDAI MOTOR COMPANY, Seoul (KR); KIA CORPORATION, Seoul (KR)

(21) Appl. No.: 18/943,481

(22) Filed: Nov. 11, 2024

(30) Foreign Application Priority Data
Mar. 29, 2024 (KR) 10-2024-0043190

(51) Int. Cl. B60H 1/32; B60H 1/00

(52) U.S. Cl. CPC B60H 1/3227; B60H 1/00028; B60H 1/00371; B60H 1/00521; B60H 1/323; B60H 2001/00235

(57) ABSTRACT

A dual inverter two-cycle roof mounted air conditioning system for a motorized vehicle may form a first cooling cycle of a built-in inverter type first compressor and first evaporator and a second cooling cycle of a built-in inverter type second compressor and second evaporator as independent two-directional refrigerant paths in a state in which one condenser is installed in the internal space of an air conditioner case as a single core condenser. This secures required cooling performance using a miniaturized dual compressor and reduces the inverter capacity using the power topology of a miniaturized dual inverter.

### CROSS-REFERENCE TO RELATED APPLICATION

This application claims priority to Korean Patent Application No. 10-2024-0043190, filed on Mar. 29, 2024, which is incorporated herein by reference in its entirety.

### BACKGROUND OF THE DISCLOSURE

### Technical Field

The present disclosure relates to an air conditioning system for a motorized vehicle, and more specifically, to a high efficiency and low cost dual inverter two-cycle roof mounted air conditioning system for a motorized vehicle.

### Description of Related Art

Generally, an air conditioning system for cooling the interior of a motorized vehicle (e.g., a bus) adopts, as an air conditioner architecture, center portion arrangement of a condenser (i.e., a condenser core) and a fan/motor in an air conditioner unit, left/right symmetrical installation of an evaporator (i.e., an evaporator core) and a blower in the air conditioner case, and an air conditioner height forward ejection method after heat exchange with the condenser core of the air suctioned in all directions of the air conditioner. This architecture is in a state of being already optimized and standardized as an air conditioner architecture for an air conditioning system of an internal combustion engine bus.

In addition, the air conditioning system for a motorized vehicle has the unique feature in which a compressor and a voltage converter, which are high-voltage operating components, are installed in an air conditioning unit, making it significantly different from an air conditioner for an internal combustion engine.

Therefore, the air conditioning system for a motorized vehicle is based on a roof mounted type unit used in an air conditioning system for an internal combustion engine bus. Also, the air conditioning system is standardized by setting the assembly of a high voltage electric compressor and transformers (e.g., a converter and an inverter) for converting a vehicle voltage as a typical form factor.

For example, the form factor allows removal of complex connection piping between an engine compartment and an air conditioning unit, vehicle engineering holes, and brackets. Also, the form factor has structural features that enable pre-injection of refrigerant into the system to provide an advantage that unit-per-hour (UPH) of vehicle manufacturers can increase.

Therefore, at this point, the form factor is a top priority for the air conditioning system in motorized buses. The form factor is also considered a standard for global bus air conditioner manufacturers.

However, the air conditioning system for a motorized vehicle requires optimization of the air conditioner architecture so that the compressor and voltage converter (e.g., an inverter and a converter), which account for a very large proportion of the cooling performance, cost, weight, and consumed power of the components, are installed in the air conditioner unit.

One reason is that, in the air conditioning system for a motorized vehicle, the compressor is a scroll type compressor with an AC motor built-in, has 32 kW for about 80 to 99 cc of the discharge amount per rotation to maintain cooling comfort of about 11 to 12 m class of bus, and is mounted on a separate frame mainly provided in an empty space of a front surface of the air conditioner to be connected to a condenser and an evaporator in a single cycle. Another reason is that the voltage converter (e.g., the inverter and the converter) needs to be mounted by securing an unused space near the compressor or inside a case to drive an AC motor of the compressor and a DC motor of a fan by receiving a high voltage of a vehicle battery.

In particular, the air conditioning system of the motorized vehicle affects fuel efficiency and all electric range (AER) more than the case of the internal combustion engine. Further, the air conditioning system is more sensitive to noise, vibration, harshness (NVH), and is known as having improved total cost of ownership (TCO) due to being lightweight. Therefore, there is a need for the optimization of the air conditioner inner architecture for the air conditioning system for a motorized vehicle in consideration of securing target cooling performance and saving the material cost together with three factors of consumed power saving, vibrations/noise improvement, and weight saving.

Furthermore, as commercial buses (e.g., public transportation buses) have recently faced a rapid transition to electrification, the need for optimizing the internal architecture of air conditioners for an air conditioning system for a motorized bus is increasingly emerging.

### SUMMARY OF THE DISCLOSURE

In view of the foregoing, the present disclosure is directed to providing a dual inverter two-cycle roof mounted air conditioning system for a motorized vehicle. In such an air conditioning system, a left/right separation structure of a single core condenser, an integrated heat-dissipation structure of a condenser/inverter/converter, an air conditioner case floor upward cooling structure of the compressor/inverter/converter, and dual insulated compressor mounting structure connected to an air conditioner case connection member are applied as differentiated features for the internal architecture. In particular, the capacity of the inverter may be reduced by power topology of compressor motor rotation control by the dual inverter. Also, the compressor may be miniaturized by securing required cooling performance by the dual cycle of the dual compressor.

To achieve the foregoing objects, a dual inverter two-cycle roof mounted air conditioning system for a motorized vehicle according to an embodiment of the present disclosure is provided. The air conditioner system includes a first compressor and a second compressor that are disposed in a vehicle width direction. The air conditioning system further includes a condenser disposed in a vehicle longitudinal direction. The air conditioning system also includes a first evaporator and a second evaporator that are disposed at left and right sides of the condenser. A first cooling cycle including the first compressor and the first evaporator, and a second cooling cycle including the second compressor and the second evaporator each have a left-right two directional independent refrigerant path.

The condenser may be a single core. An area of the single core may be used by being divided in the first cooling cycle and the second cooling cycle.

An inverter may be built into each of the first compressor and the second compressor.

A converter for driving a motor in the air conditioning system may be disposed so that the first compressor and the second compressor are located between the converter and the condenser.

The converter may be installed to be spaced by a predetermined distance upward from a bottom surface of the air conditioning system. A condenser fan located above the condenser may form an air flow from a front or rear side of the air conditioning system along the converter, the first compressor, the second compressor, and the condenser.

A condenser fan located above the condenser may form an air flow from left and right sides of the air conditioning system along the first compressor, the second compressor, and the condenser.

The converter may be connected to motors of first and second blowers mounted in installation spaces of the first evaporator and the second evaporator.

The air conditioning system may further include an air conditioner case in which each of the converter, the first compressor, the second compressor, and the condenser is installed. The air conditioner case may be formed with a heat-dissipation area in which a surrounding space of the converter, the first compressor, the second compressor, and the condenser thermally exchanges heat with outside air.

The air conditioner case may form an air conditioner case bottom upward structure. The air conditioner case bottom upward structure may form a lower height spaced apart from an upper surface of the vehicle body roof at an upward bottom inclined angle facing the center of the air conditioner case.

The air conditioner case may mount a converter mounting bracket on a case bottom. The converter mounting bracket may locate an installation location of the converter at an upper height matching a roof panel of the vehicle body roof. The upper height and the lower height may diffuse the flow of outside air to four surfaces of the converter.

The air conditioner case may form a dual-insulated compressor mounting structure in the installation spaces of the first compressor and the second compressor. The dual-insulated compressor mounting structure may include base members installed on an air conditioner case bottom to provide a mounting space for each of the first compressor and the second compressor. The dual-insulated compressor mounting structure may further include a compressor bracket fixing the first compressor and the second compressor to the base members, respectively.

The base members may include a compressor mounting plate on which each of the first compressor and the second compressor is located. The base members may further include an air conditioner case connection bar fixed to the bottom of the air conditioner case to support the compressor mounting plate. The compressor bracket may have an arch structure into which two bushes and two insulators are inserted and has a separation space with the compressor mounting plate.

Each of the bush and the insulator may reduce the compressor response characteristics for compressor rotation vibrations generated by driving the first compressor and the second compressor.

In addition, to achieve the foregoing objects, a dual inverter two-cycle roof mounted air conditioning system for a motorized vehicle according to an embodiment of the present disclosure is provided. The air conditioning system includes: at a top location of a vehicle body roof, a condenser arranged in a direction parallel to a first compressor and a second compressor; a first evaporator arranged in a direction parallel to the first compressor; and a second evaporator arranged in a direction parallel to the second compressor. A cooling cycle has an independent two directional refrigerant path with a first cooling cycle connecting the first compressor, the condenser, and the first evaporator and a second cooling cycle connecting the second compressor, the condenser, and the second evaporator.

Each of the first cooling cycle and the second cooling cycle may be connected to a refrigerant circulation pipe. The refrigerant circulation pipe may be arranged in installation spaces of the first compressor and the second compressor behind the condenser. A thermal expansion valve (TXV) is installed on the refrigerant circulation pipe.

The dual inverter two-cycle roof mounted air conditioning system for a motorized vehicle according to an embodiment of the present disclosure implements the following operations and effects compared to the conventional technology in a motorized bus.

The first is cost reduction. This is possible by reducing the cost per unit through miniaturization and modification of major components such as a compressor, an inverter, and a converter.

The second is weight reduction. This is possible by reducing the weight of each unit through a small compressor and converter integrated with a built-in inverter, in particular, motorized buses may increase the all-electric range (AER), which is the pure electric driving range, from the weight reduction effect of the air conditioning system and have a positive impact on the durability of drive/brake components.

The third is consumed power reduction. This is proven as the fact indicating that the air conditioning system having an internal architecture structure to which differentiated features are applied reduces about 32% of the power compared to the conventional air conditioning system when the air conditioner is operated at maximum load for 90 minutes under environmental conditions of 35° C. of an outside air temperature and 830 W/m² of solar radiation.

The fourth is an increase in the customer's total cost of ownership (TCO). This means that the compressor and the transformer, which account for about 50% or more of the cost in the air conditioner unit having an internal architecture to which the differentiated features are applied, may be changed to low-cost mass products based on economies of scale, thereby reducing after-sales service costs.

The fifth is the improvement of vibration noise. This is proven as an improvement in noise from 77 dBc to 69 dBc (about 10%) through the measurement result of the microphone at major interior locations of the motorized bus and the improvement in vibrations from Juri 7− to 7+ through the measurement result of vibrations transmitted to the passenger seats or the stanchion pipe in the air conditioner during the air conditioner operation of the air conditioning system having the internal architecture to which the differentiated features are applied.

### BRIEF DESCRIPTION OF THE DRAWINGS

FIG. 1 shows a configuration of a dual inverter two-cycle roof mounted air conditioning system for a motorized vehicle according to an embodiment of the present disclosure.

FIG. 2 shows a detailed configuration of the dual inverter two-cycle roof mounted air conditioning system for a motorized vehicle according to an embodiment of the present disclosure.

FIG. 3 is a block diagram illustrating an example of a configuration of a power topology including a dual inverter for reducing the capacity of an inverter for compressor motor rotation control according to an embodiment the present disclosure.

FIG. 4 is a block diagram illustrating an example of a configuration of the dual compressor two-cycle cooling system for securing required cooling performance using a small compressor according to an embodiment of the present disclosure.

FIG. 5 shows two independent dual refrigerant path structures for first and second cooling cycles of a single core condenser according to an embodiment of the present disclosure.

FIG. 6 shows an airflow state of the single core condenser having the two independent refrigerant paths according to an embodiment of the present disclosure.

FIG. 7 shows an integrated heat dissipation structure of a condenser, a compressor, an inverter, a fan, a motor, and a converter according to an embodiment of the present disclosure.

FIG. 8 shows an example of a structure moved up from the bottom of an air conditioner case to easily cool the compressor, the inverter, and the converter according to an embodiment of the present disclosure.

FIG. 9 shows a compressor vibration transmission state according to an embodiment of the present disclosure.

FIG. 10 shows an example of a dual-insulated compressor mounting structure connected to an air conditioner case connection member according to an embodiment of the present disclosure.

### DETAILED DESCRIPTION

Hereinafter, embodiments of the present disclosure are described in detail with reference to the accompanying drawings. Embodiments are examples and may be implemented in various different forms by those having ordinary skill in the art to which the present disclosure pertains. Therefore, the present disclosure is not be limited to the embodiments disclosed herein.

Hereinafter, among the xyz coordinates, an X-axis indicates a vehicle longitudinal direction or front/rear, a Y-axis indicates a vehicle width direction or left/right, and a Z-axis indicates a vehicle height direction or top/bottom. When a component, device, element, or the like of the present disclosure is described as having a purpose or performing an operation, function, or the like, the component, device, or element should be considered herein as being “configured to” meet that purpose or perform that operation or function.

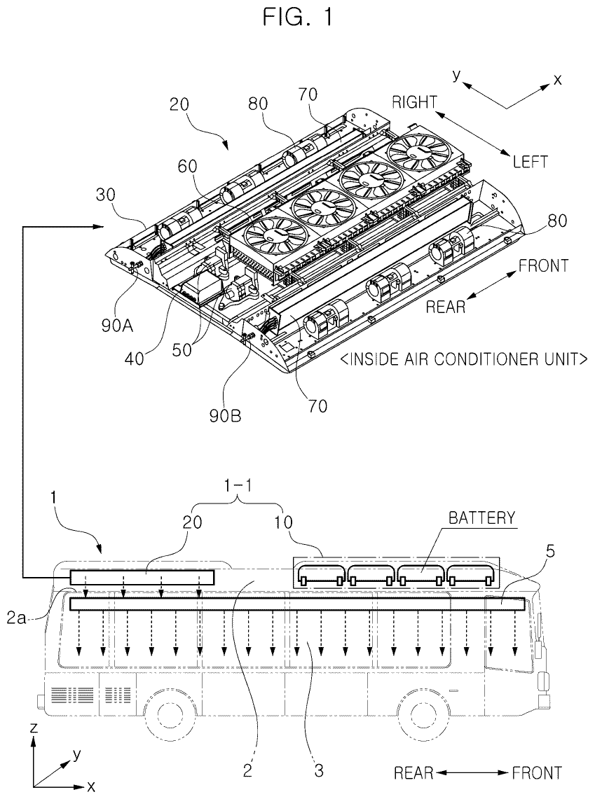

Referring to FIG. 1, a roof mounted air conditioning system 1-1 of a motorized vehicle 1 includes a battery 10 and an air conditioner unit 20 that are installed on (i.e., mounted on) a vehicle body roof 2 in a front-rear direction (i.e., the X-axis of the xyz coordinates) of the vehicle.

For example, the battery 10 is located at the front of the vehicle to supply power necessary for operating the air conditioner unit 20. The air conditioner unit 20 is located at the rear of the vehicle to perform a refrigerant cycle by the power of the battery 10. In this example, the battery 10 is composed of a plurality of battery groups having a predetermined capacity to supply necessary power.

Therefore, the roof mounted air conditioning system 1-1 cools a vehicle interior 3 by sending cold air from the air conditioner unit 20 to an air conditioner duct 5 arranged along the vehicle body roof 2.

Specifically, the air conditioner unit 20 includes an air conditioner case 30. The air conditioner case 30 has an internal architecture in which a converter 40/inverter 51, which are voltage conversion devices, and a compressor 50, a condenser 60, an evaporator 70, and a blower 80, which are refrigerant compression, are arranged together, which is differentiated from the conventional architecture structure.

For example, among the converter 40 and the inverter 51, which are the voltage conversion devices, the converter 40 converts high voltage power of the battery 10 into a direct current and supplies the direct current, and the inverter 51 converts the high voltage power of the battery 10 into an alternating current and supplies the alternating current.

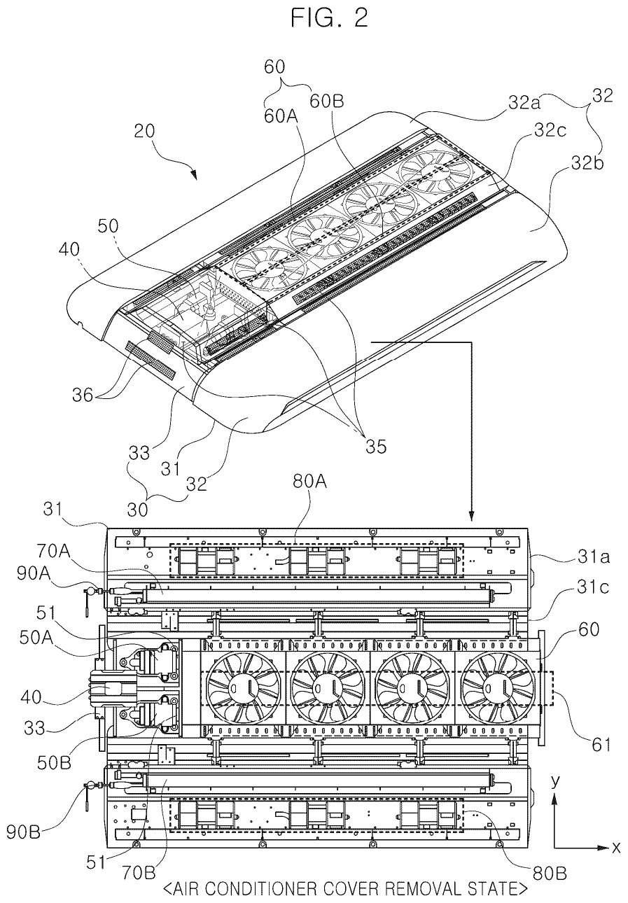

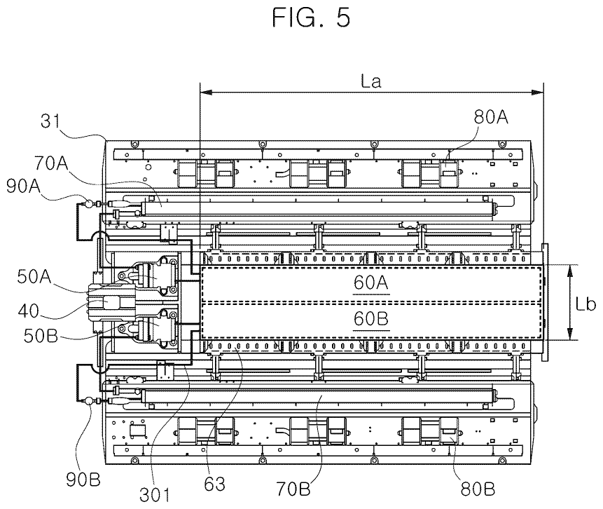

For example, the compressor 50 is driven by the inverter 51 to compress low-temperature/low-pressure refrigerant and discharges the compressed refrigerant to the condenser 60 through a refrigerant circulation pipe 301 (see FIG. 5). The condenser 60 condenses high-temperature/high-pressure refrigerant of the compressor 50 using a blowing operation of a condenser fan 61 (see FIG. 2) to generate medium-temperature/high pressure. The evaporator 70 evaporates low-temperature/low-pressure wet-saturated expanded refrigerant output from the condenser 60 through heat-exchange with outside air to re-send the refrigerant in a gaseous state to the compressor 50 through the refrigerant circulation pipe 301 (see FIG. 5).

In particular, in the refrigerant cycle, first and second thermal expansion valves (TXVs) 90A and 90B rapidly expand the refrigerant output from the condenser 60 and convert the refrigerant into a low-temperature/low-pressure wet-saturated gas state and send the converted refrigerant to the evaporator 70.

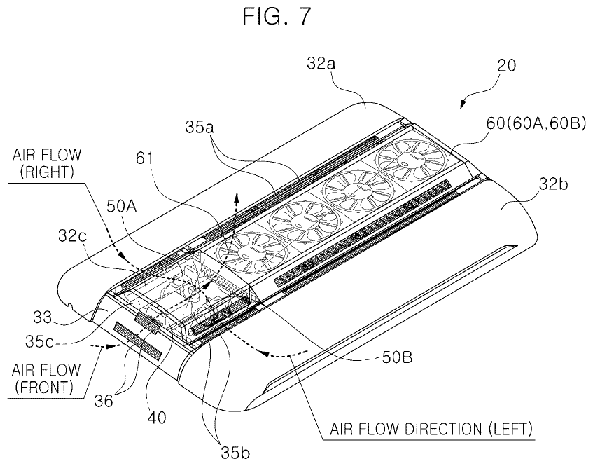

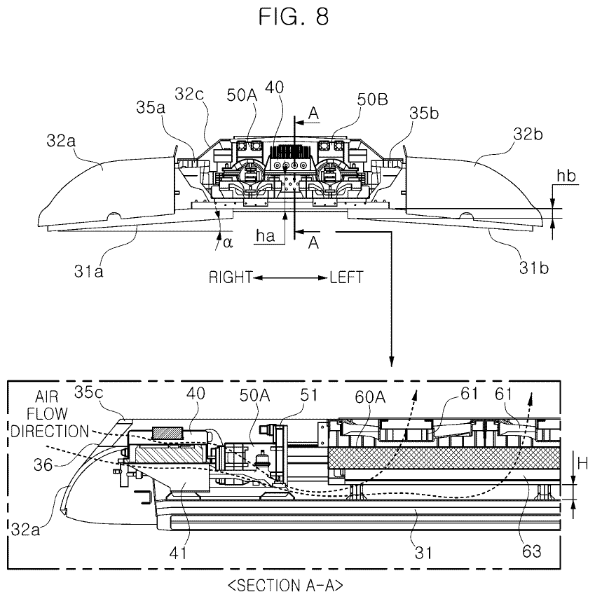

For example, the blower 80 introduces the vehicle's inside/outside air into the air conditioner case 30 (see FIGS. 7 and 8). The air inside the case is converted into cold air through the evaporator 70 to cool the interior and is blown into the vehicle interior 3 from the air conditioner duct 5.

FIG. 2 shows a detailed configuration of the air conditioner unit 20 and shows a roof mounted air conditioning system 1-1. In the air conditioning system 1-1, a first cooling cycle 300A including a first compressor 50A and a first evaporator 70A and a second cooling cycle 300B including a second compressor 50B and a second evaporator 70B configures an independent refrigerant path in two left and right direction, respectively through the first and second compressors 50A and 50B disposed in a vehicle width direction. In the air conditioning system 1-1, a condenser 60 disposed in a vehicle longitudinal direction, and the first and second evaporators 70A and 70B disposed at left and right sides of the condenser 60.

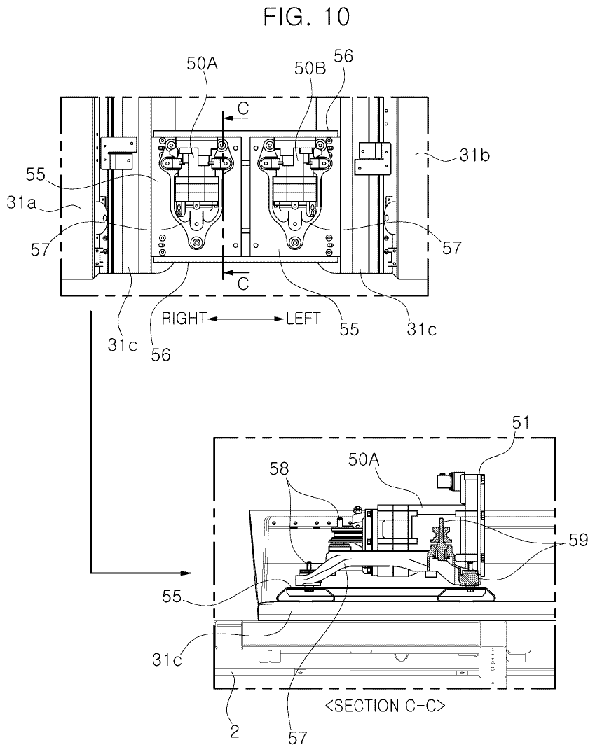

Specifically, the air conditioner case 30 is composed of a case tray 31, a case upper cover 32, and a case side cover 33. The case tray 31 provides a component installation portion and is fastened to a vehicle body roof 2 using a vehicle body mounting bolt 7 (see FIG. 10). The case cover 32 covers the case tray 31 so that the components 40, 50, 60, 70, and 80 form an internal space covered from the outside. The case side cover 33 is coupled to a middle section between the case tray 31 and the case cover 32 to block an internal space.

For example, when a length in a front-rear direction of an X-axis and a width in a left-right direction of a Y-axis in xyz coordinates are applied to a rectangular plate, the width (Y-axis of the xyz coordinates) in the left-right direction divides the case tray 31 into three parts of first and second mounting parts 31a and 31b and a central mounting part 31c. The converter 40, the compressor 50, and the condenser 60 are sequentially arranged from the rear side to the front side in the front-rear direction on the central mounting part 31c. The evaporator 70 and the blower 80 are arranged in the front-rear direction (i.e., X-axis direction of the xyz coordinates) on each of the first and second mounting parts 31a and 31b so as to be disposed parallel to the condenser 60.

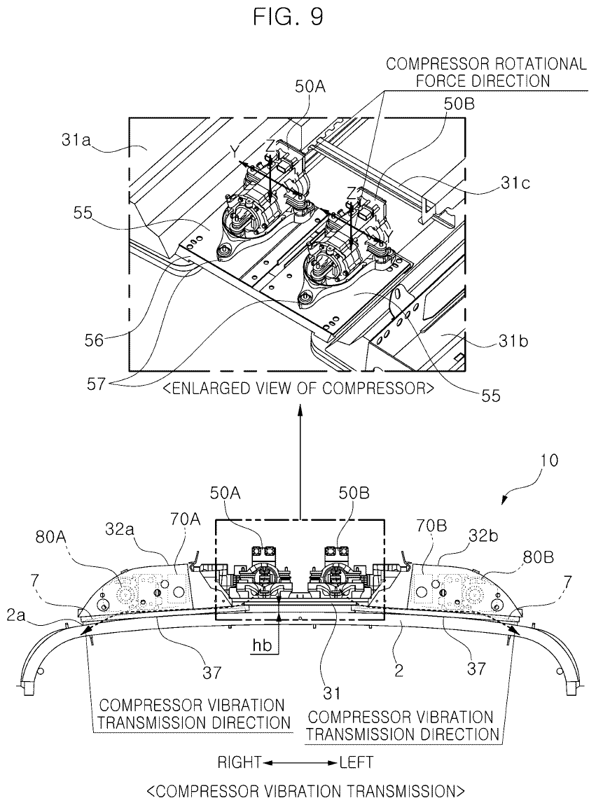

In the case tray 31, separate frames (see FIGS. 9 and 10) are installed at an interval in an empty space of a front surface of the air conditioner in the front-rear direction (i.e., the X-axis direction of the xyz coordinates). The structure of the frame is provided as a portion in which the converter 40, the compressor 50, and the condenser 60 are disposed and fastened using a bolt by securing an unused space inside the case.

In addition, the first mounting part 31a and the second mounting part 31b of the first and second mounting parts 31a and 31b have the same shape that partitions installation spaces of the evaporator 70 and the blower 80 using a partition wall along the length in the front-rear direction (i.e., the X-axis direction of the xyz coordinates). The first mounting part 31a is provided as the installation space of a first evaporator 70A and a first blower 80A among the evaporator 70 and the blower 80. The second mounting part 31b is provided as the installation space of a second evaporator 70B and a second blower 80B of the evaporator 70 and the blower 80.

For example, the case upper cover 32 is composed of first and second covers 32a and 32b and a central cover 32c. Each of the first and second covers 32a and 32b covers the first and second mounting parts 31a and 31b of the case tray 31. The central cover 32c cover the central mounting part 31c of the case tray 31.

For example, the case side cover 33 is coupled to the converter 40 while covering a front surface of the central cover 32c in the front-rear direction (i.e., the X-axis direction of the xyz coordinates).

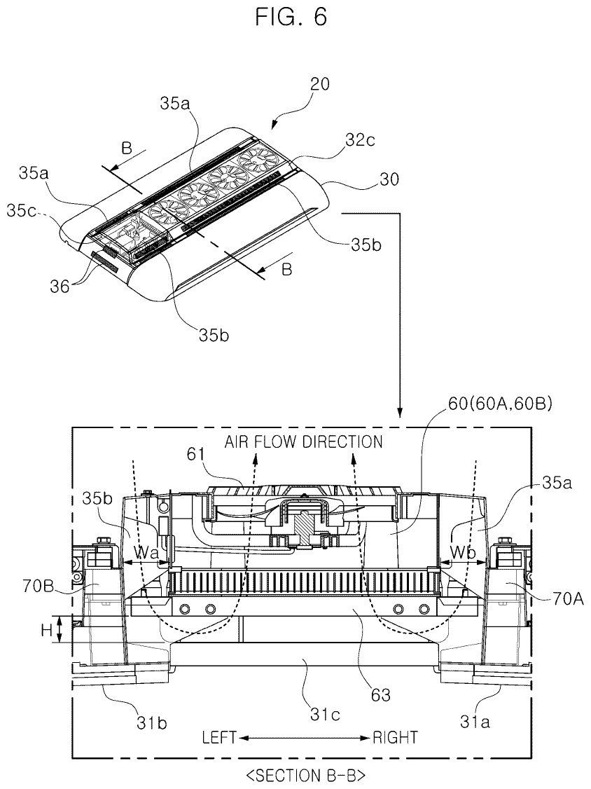

In addition, the air conditioner case 30 forms an airflow direction (see FIGS. 6, 7, and 8) flowing from the outside to the inside using external air intake ports 35 and 36 using the central cover 32c of the case upper cover 32 and the case side cover 33.

For example, the external air intake ports 35 and 36 are classified into the cover intake port 35 of the central cover 32c and the side cover intake port 36 of the case side cover 33. In particular, the cover intake port 35 is formed to be spaced at a regular interval from the case side cover 33 on the width of the central cover 32c in the left-right direction (Y-axis of the xyz coordinates) while a plurality of cover intake ports having a length difference perforate on the length (i.e., the X-axis direction of the xyz coordinates) of the central cover 32c in the front-rear direction. Two side cover intake port 36 having a length difference perforate in the case side cover 33.

For example, the converter 40 is located in the central mounting part 31c of the case tray 31 of the air conditioner case 30, coupled to the case side cover 33, and is electrically connected to a battery 10 to provide power for driving 24 V motors in the air conditioner unit 20.

In other words, the converter 40 is disposed so that the first and second compressors 50A and 50B are located between the converter 40 and the condenser 60 to drive the motor in the air conditioning system. As shown in FIG. 8, the converter 40 is installed to be spaced at a predetermined distance upward from a bottom surface of the air conditioning system.

For example, the compressor 50 is a scroll-type compressor in which an AC motor composed of the two first and second compressors 50A and 50B each having the inverter 51 is built in and located at a location of the central mounting part 31c in front of (i.e., forward direction of the X-axis of the xyz coordinates) the converter 40 among the case tray 31 of the air conditioner case 30. A combination of the first compressor 50A and the second compressor 50B is configured according to the required performance (e.g., 32 kW and 80 to 90 cc of discharge amount per rotation) to maintain the cooling comfort of the motorized vehicle 1 (e.g., a motorized bus having 11 to 12 m class of full length).

Therefore, the first and second compressors 50A and 50B are configured of a dual inverter and a compressor having the same specification in consideration of an exponential increase in weights and costs of the components as a power conversion capacity of the inverter becomes double. A configuration of the dual inverter and the compressor uses about half of the displacement and output (e.g., consumed power of 9 kW or more of large capacity) of the motor compared to one large-capacity compressor in the related art, thereby also reducing the output power capacity of the inverter 51 to about half. Therefore, it is possible to secure the significant cost/weight reduction effect and minimize the cost required upon replacing components due to failure in view of the customer total cost of ownership (TCO), thereby reducing the total maintenance cost of the customer in the total lifecycle.

For example, the condenser 60 is located at a location of the central mounting part 31c in front of (i.e., forward of the X-axis of the xyz coordinates) the first and second compressors 50A and 50B of the case tray 31 of the air conditioner case 30. The condenser 60 is composed of a first condenser core 60A and a second condenser core 60B arranged in series.

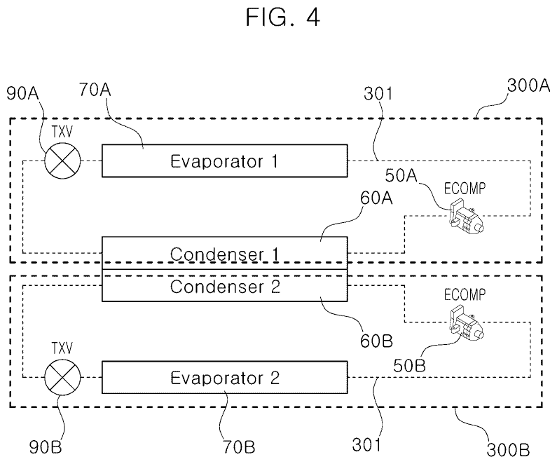

In other words, the condenser 60 is a single core, and an area of the single core is used by being divided in the first cooling cycle and the second cooling cycle (see FIG. 4).

Therefore, the condenser 60 has two independent refrigerant passes (see FIG. 5) at left and right sides of one heat exchanger through the first and second condenser cores 60A and 60B, respectively. The first and second condenser cores 60A and 60B are each configured together with the condenser fan 61. Two condenser fan 61 are arranged in each of the first and second condenser cores 60A and 60B to suction outside air into an internal space of the air conditioner case 30.

In other words, the condenser fan 61 located at the top of the condenser 60 forms an air flow in the left-right direction of the air conditioning system while forming an air flow from the front or rear side of the air conditioning system along the converter 40, the first and second compressors 50A and 50B, and the condenser 60.

The first and second condenser cores 60A and 60B are arranged in series subsequent to the converter 40 and the compressor 50 to solve all problems caused by the conventional arrangement (i.e., a middle location in the X-axis direction of the xyz coordinates) of the two condenser cores in the central portion of the air conditioner unit. The problems are: 1) an increase in ventilation resistance upon heat exchange due to an increase in complexity of the condenser core part by additional discharge and liquid piping; 2) total heat-dissipation area loss (e.g., about 6 to 7%) due to an empty space of a connection part between the two condenser core; and 3) reduction in cross section of an intake port at an inlet of the condenser having the trade-off relationship caused by an increase in the length in the width direction of the condenser core for eliminating the lack of the heat-dissipation area and the increase in the ventilation resistance, and the like.

For example, the evaporator 70 is composed of the first evaporator 70A arranged (i.e., forward of the X-axis of the xyz coordinates) parallel to the first condenser core 60A in the first mounting part 31a of the case tray 31 of the air conditioner case 30, and the second evaporator 70B arranged (i.e., forward of the X-axis of the xyz coordinates) parallel to the second condenser 60B in the second mounting part 31b.

The first and second evaporators 70A and 70B have the same specification and have two independent refrigerant paths at the left and right sides (see FIG. 5), respectively, connected to one end thereof.

For example, the blower 80 is composed of the first blower 80A arranged (i.e., forward of the X-axis of the xyz coordinates) parallel to the first evaporator 70A in the first mounting part 31a of the case tray 31 of the air conditioner case 30, and the second blower 80B spaced (i.e., forward of the X-axis of the xyz coordinates) at an interval from the second evaporator 70B in the second mounting part 31b.

The first and second blowers 80A and 80B have the same specification and each form a blower group with three blowers.

Therefore, the air conditioner unit 20 can acquire the improved effects compared to various viewpoints of the air conditioner architecture for an internal combustion engine by adopting, as the differentiated features: the left-right separation structure of the single core condenser, the integrated heat-dissipation structure of the condenser, the inverter, and the converter; the air conditioner case bottom upward structure of the compressor, the inverter, and the converter; and the double-insulated compressor mounting structure connected to the air conditioner case connection member, based on the center arrangement of the condenser and the fan and the left-right symmetric arrangement of the evaporator and the blower.

Therefore, the air conditioner unit 20 characterizes the roof mounted air conditioning system 1-1 as the high-efficiency and low-cost dual inverter roof mounted air conditioning system 1-1 suitable for a bus among the motorized vehicles 1.

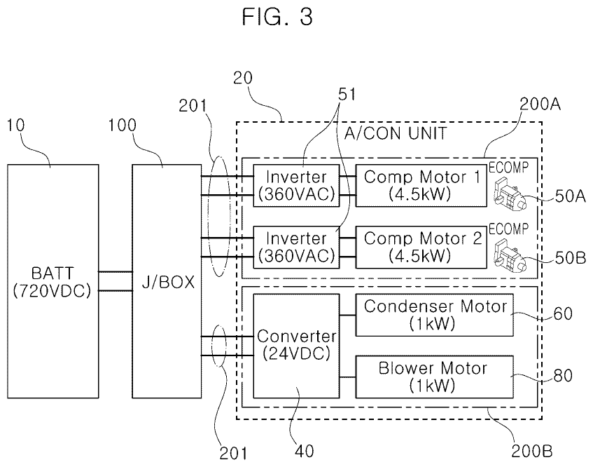

FIGS. 3-10 specifically show a configuration of the power topology, the two cooling cycle of the dual compressor, a configuration of the dual refrigerant paths, the integrated heat dissipation configuration, and the double-insulated compressor mounting configuration for the air conditioner unit 20.

Referring to FIG. 3, the power topology of the air conditioner unit 20 shows that the high voltage power of the battery 10 received from the vehicle is subjected to a transformation process through a junction box 100 of the air conditioner and then is divided into the converter 40, which is a DC electric part 200B connected by an electric wire 201, and the inverters 51 of the first and second compressors 50A and 50B, which are an AC electric part 200A.

Therefore, the AC electric part 200A is connected to motor loads (i.e., compressor motors) of the first and second compressors 50A and 50B, and the DC electric part 200B is connected to the motor load of the condenser fan 61 (i.e., the condenser motor and the blower motor) of each of the condenser 60 and the blower 80.

In particular, the combination of the first and second compressors 50A and 50B is each 4.5 kW or more according to the consumed power of the 9 kW motor. The inverter 51 is 360 VAC (voltage alternating current). In addition, the converter 40 has 24 VDC (voltage direct current). The condenser motor (i.e., the condenser fan) and the blower motor each consume 1 KW of power.

Referring to FIG. 4, the dual compressor two-cycle cooling of the air conditioner unit 20 constitutes the first cooling cycle 300A by the first compressor 50A and the second cooling cycle 300B by the second compressor 50B by adopting the first and second compressors 50A and 50B that are small compressors.

For example, the first cooling cycle 300A has a first cycle and is composed of the first compressor 50A, the first condenser core 60A, a first TXV 90A, and a first evaporator 70A that form a closed circuit using the refrigerant circulation pipe 301. The second cooling cycle 300B has a second cycle and is composed of the second compressor 50B, the second condenser 60B, the second TXV 90B, and the second evaporator 70B that form a closed circuit using the separate refrigerant circulation pipe 301.

As described above, the first and second cooling cycles 300A and 300B may be composed of two fully independent cycles, thereby solving problems of noise in the system and quality of compressor sticking due to difficulty in securing discharge balance between the compressors 50A and 50B.

Therefore, through the first and second cycles of the first and second cooling cycles 300A and 300B, it is possible to secure the refrigerant displacement suitable for required cooling performance using two small-capacity compressors 50A and 50B in a situation in which the satisfaction of the customer demand cooling performance in tropical, Middle Eastern, hot weather areas as well as general temperate areas is not possible using one small-capacity compressor having half the displacement per rotation compared to the conventional single cycle.

Referring to FIG. 5, the refrigerant circulation pipe 301 has two dual independent refrigerant paths. The first and second condenser cores 60A and 60B of the condenser 60 each have two independent refrigerants at each of left and right sides of one heat exchanger.

Therefore, the condenser 60 may allow the first compressor 50A and the first evaporator 70A to use only 50% of a core area at the left side and also allow the second compressor 50B and the second evaporator 70B to use a core area of the remaining 50% at the right with respect to the center of the first and second condenser cores 60A and 60B. In this example, the core area is calculated by multiplying a horizontal length La (i.e., the X-axis direction of the xyz coordinates) and a vertical length Lb (i.e., the Y-axis direction of the xyz coordinates) of the condenser.

Therefore, the independent two refrigerant path structure using the refrigerant circulation pipe 301 of the single core condenser 60 adopts the condenser core (i.e., the first and second condenser cores 60A and 60B) having the two independent refrigerant paths at the left and right sides of one heat exchanger. Thus, the first compressor 50A, which is the right compressor of the air conditioner unit 20, and the first evaporator 70A may constitute the right side with respect to the center of the condenser core. Also, the second compressor 50B, which is the left compressor, and the second evaporator 70B may constitute the remaining left core area with respect to the center of the condenser core.

Therefore, by adopting the structure of the single condenser core having the independent two-directional refrigerant paths, it is possible to eliminate the unused area that may occur in the two independent first and second condenser cores 60A and 60B, thereby securing an increase in the heat-dissipation area. It is also possible to improve the conventional structural complexity of the connection of the pipes in which the refrigerant circulation pipe 301 crosses the center of the condenser core, thereby easily securing the ventilation area for smooth introduction of outside air. Therefore, it is possible to secure the heat-dissipation area of the condenser 60 and minimize the ventilation resistance of the air flow, thereby providing advantages in design.

As described above, through the description of FIGS. 3-5, the power topology for the motor rotation control of the dual inverter type dual compressor through the two inverters 51 respectively applied to the first and second compressors 50A and 50B enables a reduction in the inverter capacity and enables the miniaturization of the compressor by securing the required cooling performance with the dual cycle of the first and second compressors 50A and 50B that are the dual compressor.

Therefore, it is possible to secure the effect of the total cost saving and the weight reduction of the vehicle identically to the dual inverter topology as the effect that may be obtained by the air conditioner unit 20. It is possible to minimize the customer or the component replacement cost. Since an operation of the other cycle is still available even when an operation of one cycle among the first and second cooling cycles 300A and 300B is not available with a problem, it is possible to reduce damage to the financial loss due to the inevitable loan of a fleet (a transportation company) due to the cooling impossibility during vehicle traveling.

Referring to FIG. 6, the cover intake port 35 of the central cover 32c of the external air intake ports 35 and 36 includes a first opening 35a perforated in the front-rear direction (i.e., the X-axis direction of the xyz coordinates) at one side the central cover 32c, a second opening 35b perforated in the front-rear direction (i.e., the X-axis direction of the xyz coordinates) at the opposite side (i.e., the width (Y-axis of the xyz coordinates) in the left-right direction) of the central cover 32c, and a third opening 35c formed at the rear side (i.e., toward the rear side of the X-axis of the xyz coordinates) of the central cover 32c.

In other words, the air conditioner case 30 includes the external air intake ports 35 and 36 through which the outside air is introduced when the condenser fan 61 of the condenser 60 is driven formed on three surfaces of four surfaces in the front and rear/left and right directions, and the external air intake ports 35 and 36 communicate with a lower ventilation space H formed between the condenser housing 63 and the bottom of the air conditioner case 30 at an interval.

Each of the first and second openings 35a and 35b has a slot structure forming one rectangular length or two shot rectangular length, and the third opening 35c has a trapezoidal protrusion structure formed by the central cover 32c and the case side cover 33.

In addition, the condenser 60 is installed on the central mounting part 31c of the case tray 31 of the air conditioner case 30 through the condenser housing 63 surrounding the condenser core. The size of the condenser housing 63 is a width forming first and second side intake spaces Wa and Wb, respectively, with respect to the left/right portions (Y-axis direction of the xyz coordinates) of the central mounting part 31c and is a height forming the lower ventilation space H with respect to the bottom portion (Z-axis of the xyz coordinates) of the central mounting part 31c.

In particular, as the refrigerant circulation pipe 301 is intensively disposed toward the first and second compressors 50A and 50B in the first and second side intake spaces Wa and Wb to improve the structural complexity of the pipes crossing the center of the conventional core, the cross-sectional length increases to about twice the conventional length of the intake port. Due to the increase in the cross-sectional length of the intake port, it is possible to provide a design advantage in securing the ventilation area for smooth introduction of outside air and minimizing the ventilation resistance. It is also possible to also provide a design advantage in securing the heat-dissipation area of the condenser cores 60A and 60B.

Therefore, when the outside air is suctioned to the internal space of the air conditioner case 30 by driving the condenser fan 61, the outside air forms an air flow direction (Z-axis of the xyz coordinates) that enters the first side intake space Wb and passes through the half sections of the condenser cores 60A and 60B in the lower ventilation space H and forms an air flow direction (Z-axis direction of the xyz coordinates) that enters the second side intake space Wa that is an opposite side and passes through the other half sections of the condenser cores 60A and 60B in the lower ventilation space H, which further increases the heat-dissipation effect for the condenser 60.

Referring to FIG. 7, the external air intake ports 35 and 36 are formed on three surfaces of the first and second openings 35a and 35b at the left-right directional sides, the third opening 35c at the rear side, and the side cover intake port 36 among four surfaces of the air conditioner case 30 in the front and rear/left and right directions.

Therefore, a combination of the first, second, and third openings 35a, 35b, and 35c and the side cover intake port 36 forms the integrated heat-dissipation structure of the converter 40, the compressor 50 (i.e., the compressor motor), the inverter 51, the condenser 60, and the condenser fan 61 (i.e., the fan motor). Such an integrated heat-dissipation structure forms the outside air flow as the rightward air flow (Y-axis of the xyz coordinates) of the outside air introduction through the first opening 35a, the leftward air flow (Y-axis direction of the xyz coordinates) of the outside air introduction through the second opening 35b, and the forward air flow (X-axis direction of the xyz coordinates) of the outside air introduction through the third opening 35c and the side cover intake port 36.

Therefore, in a state in which the inverter 51 built in the converter 40 and the first and second compressors 50A and 50B is disposed at the front (X-axis direction of the xyz coordinates) of the condenser fan 61, the integrated heat-dissipation structure enables integrated cooling by simultaneously bringing forward air flow, which is the forward air flow of the outside air introduced upon operation of the fan motor of the condenser fan 61, and left and right air flow, which is the left-right side air flow, in contact with all components 40, 50, 51, 60, and 61.

In particular, the integrated cooling method provides both the cooling effect for the converter 40 and the inverter 51 of which temperature increases quickly due to an increase in a consumed current in a high-load condition and an increase in the size of the evaporator heat exchanger due to the mounting of the major components (i.e., the converter 40, the compressor 50, and the inverter 51) outside the installation spaces of the first and second evaporators 70A and 70B and the direct heat-dissipation removal effect of the interior cooling air flow occurring upon cooling of the transformers (i.e., the converter 40 and the inverter 51) compared to the conventional method of performing cooling by installing the transformers (i.e., the converter 40 and the inverter 51) in the first and second mounting parts 31a and 31b of the case tray 31 that is the installation spaces of the first and second evaporators 70A and 70B.

Referring to FIG. 8, the air conditioner case 30 adopts the air conditioner case bottom upward structure to easily cool the converter 40 and inverter 51 by the integrated cooling method.

As shown, the air conditioner case bottom upward structure is formed through the case tray 31, which is configured in a structure in which each of the first and second mounting parts 31a and 31b of the components of the case tray 31 forms the lower space in the central mounting part 31c at an end height hb toward the central mounting part 31c at an upward bottom inclined angle a that is an acute angle.

In addition, the air conditioner case bottom upward structure adopts a converter mounting bracket 41. The converter mounting bracket 41 lifts the converter 40 to a predetermined installation height ha as high as possible in a state of being fastened to the central mounting part 31c of the case tray 31 using a bolt. In this example, the installation height ha is set to allow the installation location of the converter 40 to be located at a height matching a roof panel 2a (See FIGS. 1 and 9) of the vehicle body roof 2.

In the cross section A-A of FIG. 8, in the air conditioner case bottom upward structure, when the converter 40 is cooled by thermally exchanging outside air introduced from the front surface of the air conditioner through the third opening 35c and the side cover intake port 36 by the operation of the condenser fan 61, the converter 40 sufficiently moves up to the installation height ha from the lower end of the air conditioner case to expand the surface of the converter housing thermally exchanged to all surfaces (i.e., four surfaces) including the upper end surface, left-right surfaces, and the lower end surface, thereby maximizing the cooling effect.

In addition, the outside air flow thermally exchanged with all surfaces (i.e., four surfaces) of the converter 40 can achieve the cooling effect while passing through the condenser core through the lower ventilation space H between the central mounting part 31c of the case tray 31 and the condenser case 63 of the condenser 60 and being discharged upward.

Referring to FIG. 9, the case tray 31 assembled to the first and second compressors 50A and 50B is fastened to the vehicle body mounting bolt 7, which is hardware seated on the roof panel placed on the vehicle body roof 2 and formed on a vehicle body frame, together with the air conditioner case pad 37.

As shown, the rotation vibrations of the compressor occurring upon high torque/high rotation of the first and second compressors 50A and 50B are transmitted in a right compressor vibration transfer direction (Y-axis direction of the xyz coordinates) in which vibrations are transmitted from the first compressor 50A toward the right roof panel and in a left compressor vibration transmission direction (Y-axis direction of the xyz coordinates) in which vibrations are transmitted from the second compressor 50B toward the left roof panel when considering the compressor rotational force transmission direction.

Therefore, when considering the aspect in which the bending rigidity of the air conditioner unit 20 acts greatly in the width direction (Y-axis direction of the xyz coordinates) compared to the longitudinal direction (X-axis direction of the xyz coordinates) due to a structure, the first and second compressors 50A and 50B are disposed in the longitudinal direction (X-axis direction of the xyz coordinates). The response characteristics of each of the first and second compressors 50A and 50B are thereby reduced.

However, the first and second compressors 50A and 50B generate rotation vibrations at high torque/high rotation. Such rotation vibrations cause vibrations of the air conditioner unit 20. However, the vehicle body roof 2 is inevitably vulnerable to vibration insulation of the air conditioner unit 20 due to the vehicle body structure having a relatively small roof frame thickness and an interior connection part compared to the vehicle bottom frame having greater rigidity.

Referring to FIG. 10, as the dual-insulated compressor mounting structure connected to the air conditioner case connection member applied to the first and second compressors 50A and 50B, it may insulate the rotation vibrations due to the high torque/high rotation of the first and second compressors 50A and 50B in the vibration insulation weak structure of the air conditioner unit 20. The transmission of vibration to the compartment of the vehicle interior 3 is thereby minimized.

As shown, the dual-insulated compressor mounting structure includes base members 55 and 56, a compressor bracket 57, a bush 58, and an insulator 59.

For example, the base member is composed of a compressor mounting plate 55 and an air conditioner case connection bar 56. The compressor mounting plate 55 has a rectangular structure having the size matching the compressor. The air conditioner case connection bar 56 has a linear rod structure. In this example, the compressor mounting plate 55 is formed of a thickness and material that assist vibration insulation by securing sufficient rigidity.

Two compressor mounting plates 55 are provided according to the first and second compressors 50A and 50B, and two air conditioner case connection bars 56 are provided to be located at front and rear portions (X-axis of the xyz coordinates) of the compressor mounting plate 55.

Therefore, the compressor mounting plate 55 and the air conditioner case connection bar 56 form a base structure in which the first and second compressors 50A and 50B are mounted. The base structure is formed so that the air conditioner case connection member 56 is arranged in a state of being fixed to the left and right portions (Y-axis direction of the xyz coordinates) of the central mounting part 31c among the case tray 31 of the air conditioner case 30 to match the front/rear ends of the compressor mounting plate 55. Two compressor mounting plates 55 are fixedly formed by bolt or screw fastening on the air conditioner case connection bar 56 in a state of being arranged in parallel.

For example, two compressor brackets 57 are provided and formed in an arch structure in which each of the first and second compressors 50A and 50B has a space with the compressor mounting plate 55 in a state of being fixed to the base structure by bolt or screw fastening.

In particular, the compressor bracket 57 provides a two-stage bush structure of a compressor bush application portion and a mounting plate bushing application portion to which a bushing 58 is coupled. The insulator 59 provides a dual insulation structure of a compressor insulator application portion and a mounting plate insulator application portion to which the insulator 59 is coupled. In this example, the bushing 58 and the insulator 59 each adopt a rubber material.

Therefore, the compressor bracket 57 can reduce vibrations for each of the first and second compressors 50A and 50B with the two-stage bushing for dual insulation into which at least two bushings 58 and two insulators 59 are inserted.

As described above, the dual inverter two-cycle roof mounted air conditioning system 1-1 for the motorized vehicle 1 according to an embodiment of the present disclosure may form the first cooling cycle 300A of the built-in inverter 51 type first compressor 50A and first evaporator 70A and the second cooling cycle 300B of the built-in inverter 51 type second compressor 50B and second evaporator 70B as the independent two directional refrigerant paths in the state in which the one condenser 60 is installed in the internal space of the air conditioner case 30 as the single core condenser. The required cooling performance is thereby secured using the miniaturized dual compressor and the inverter capacity is thereby reduced using the power topology of the miniaturized dual inverter.

The present disclosure has been described with reference to the example embodiments and the drawings, but the present disclosure is not limited thereby. The present disclosure may be carried out in various forms by those having ordinary skill in the art, to which the present disclosure pertains, within the technical spirit of the present disclosure and the scope of equivalents to the appended claims.

What is claimed is:

1. A dual inverter two-cycle roof mounted air conditioning system for a motorized vehicle, the air conditioning system comprising:
a first compressor and a second compressor that are disposed in a vehicle width direction;
a condenser disposed in a vehicle longitudinal direction; and
a first evaporator and a second evaporator that are disposed at left and right sides of the condenser,
wherein a first cooling cycle including the first compressor and the first evaporator and a second cooling cycle including the second compressor and the second evaporator each have a left-right two directional independent refrigerant path.

2. The air conditioning system of claim 1, wherein the condenser is a single core, and wherein an area of the single core is used by being divided in the first cooling cycle and the second cooling cycle.

3. The air conditioning system of claim 1, wherein an inverter is built into each of the first compressor and the second compressor.

4. The air conditioning system of claim 1, wherein a converter for driving a motor in the air conditioning system is disposed so that the first compressor and the second compressor are located between the converter and the condenser.

5. The air conditioning system of claim 4, wherein the converter is installed to be spaced by a predetermined distance upward from a bottom surface of the air conditioning system.

6. The air conditioning system of claim 4, wherein a condenser fan located above the condenser forms an air flow from a front or rear side of the air conditioning system along the converter, the first compressor, the second compressor, and the condenser.

7. The air conditioning system of claim 4, wherein a condenser fan located above the condenser forms an air flow from left and right sides of the air conditioning system along the first compressor, the second compressor, and the condenser.

8. The air conditioning system of claim 4, wherein the converter is connected to motors of first and second blowers mounted in installation spaces of the first evaporator and the second evaporator.

9. The air conditioning system of claim 4, further comprising:
an air conditioner case in which each of the converter, the first compressor, the second compressor, and the condenser is installed,
wherein the air conditioner case is formed with a heat-dissipation area in which a surrounding space of the converter, the first compressor, the second compressor, and the condenser thermally exchanges heat with outside air.

10. The air conditioning system of claim 9, wherein:
the air conditioner case forms an air conditioner case bottom upward structure; and
the air conditioner case bottom upward structure forms a lower height spaced apart from an upper surface of a vehicle body roof at an upward bottom inclined angle facing a center of the air conditioner case.

11. The air conditioning system of claim 9, wherein the air conditioner case mounts a converter mounting bracket on a case bottom, and wherein the converter mounting bracket locates an installation location of the converter at an upper height matching a roof panel of a vehicle body roof.

12. The air conditioning system of claim 9, wherein:
the air conditioner case forms a dual-insulated compressor mounting structure in installation spaces of the first compressor and the second compressor; and
the dual-insulated compressor mounting structure includes
base members installed on an air conditioner case bottom to provide a mounting space for each of the first compressor and the second compressor, and
a compressor bracket fixing the first compressor and the second compressor to the base members, respectively.

13. The air conditioning system of claim 12, wherein the base members include:
a compressor mounting plate on which each of the first compressor and the second compressor is located; and
an air conditioner case connection bar fixed to the air conditioner case bottom to support the compressor mounting plate.

14. The air conditioning system of claim 12, wherein the compressor bracket has an arch structure into which two bushings and two insulators are inserted and has a separation space with a compressor mounting plate.

15. The air conditioning system of claim 14, wherein each of the two bushings and the two insulator reduces compressor response characteristics for compressor rotation vibrations generated by driving the first compressor and the second compressor.
